(19) United States
(12) Patent Application Publication
(10) Pub. No.: US 2025/0208601 A1
(43) Pub. Date: Jun. 26, 2025

(54) INFORMATION PROCESSING DEVICE, MACHINE TOOL CONTROL DEVICE, AND NON-TRANSITORY COMPUTER-READABLE MEDIUM STORING A COMPUTER PROGRAM

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 18/727,291

(22) PCT Filed: Jan. 21, 2022
(86) PCT No.: PCT/JP2022/002151

§ 371 Date: Jan. 7, 2025

(51) Int. Cl. G05B 19/4093

(52) U.S. Cl. CPC G05B 19/40938; G05B 2219/49055; G05B 2219/49314

(57) ABSTRACT

The present invention provides a technique for reducing the workload of a machine tool user selecting one specific shaft to oscillate during processing. Provided is a machine tool control device 1, the machine tool performing oscillating cutting by oscillating only one specific shaft, said machine tool control device 1 comprising: an oscillation shaft selection unit 13 for selecting one specific shaft from among a plurality of feed shafts as an oscillation shaft when performing oscillating cutting by oscillating only one specific shaft, or not selecting any shaft as a shaft to be oscillated, on the basis of tool shape data whereby a tool shape can be recognized, positional relationship data of the relative positional relationship between a workpiece and a tool, or used tool data whereby a tool to be used can be specified, and movement data for moving the workpiece and the tool relative to each other; and an oscillation operation control unit 14 for performing control so as to oscillate the one specific shaft selected by the oscillation shaft selection unit, or performing control so as not to oscillate any feed shaft, on the basis of a processing condition and the selection result from the oscillation shaft selection unit.

### TECHNICAL FIELD

The present disclosure relates to an information processing device, a machine tool control device, and a computer program.

### BACKGROUND ART

It is known that, when a workpiece is cut using a cutting tool, chips are continuously generated and adhere to the cutting tool, which causes machining defects, failure of a machine tool, and the like. To address this, oscillating cutting has been proposed in which cutting is performed while a cutting tool and a workpiece are being relatively oscillated so that chips are shredded. Usually, the oscillating cutting is performed by relatively oscillating the cutting tool and the workpiece in a direction along a machining path.

For example, in a case where the workpiece has a tapered shape or an arc shape, a plurality of feed axes (e.g., a Z-axis and an X-axis) are used to feed the cutting tool or the workpiece in a direction along a machining path. In this case, since the plurality of axes are simultaneously oscillated, a large load is imposed on the machine tool. In view of this, a technique has been proposed in which, for a tapered portion or the like of a workpiece, an oscillation direction is changed from a direction along a machining path to a different direction, whereby a load on the machine tool can be reduced while chips are shredded (for example, see Patent Document 1).

FIG. 32 is a diagram illustrating an example of a conventional oscillating cutting. In this example, the workpiece W being rotated by the spindle S is cut by the tool T being moved by a feed shaft in a feed direction that is along a generatrix on the outer peripheral surface of the workpiece W. As illustrated in FIG. 32, in the case where a tapered portion of the workpiece W is cut by the tool T, the oscillation direction is changed: the oscillation direction during the previous pass is along the machining path, whereas the oscillation direction during the current pass is not along the machining path. For example, the oscillation direction which is along the machining path and is indicated by the black arrow in FIG. 32 is changed to the oscillation direction which is indicated by the white arrow and in which an oscillation component of the Z-axis direction increases while an oscillation component of the X-axis direction decreases.

However, in the example illustrated in FIG. 32, in which due to the change in the oscillation direction, the oscillation component of the Z-axis direction increases whereas the oscillation component of the X-axis direction decreases, the load on the machine tool can be sufficiently reduced when the inertia in the X-axis direction of the machine tool is significantly larger than the inertia in the Z-axis direction. That is, in the case of the conventional oscillating cutting, the effect of reducing the load on the machine tool depends on the configuration of the machine tool.

On the other hand, a technique has been proposed in which a plurality of feed axes are not oscillated but only one specific axis is oscillated. In the case of oscillating only one specific axis in this way, control is easy, which is considered to lead to suppression of control costs and reduction of the load on the machine tool.

### CITATION LIST

### Patent Document

Patent Document 1: Japanese Patent No. 6763917

### DISCLOSURE OF THE INVENTION

### Problems to be Solved by the Invention

In the case of oscillating only one specific axis, whether or not chips can be shredded depends on which one of axes is oscillated. However, according to the conventional technique, the axis to be oscillated is empirically determined by a user of a machine tool during machining, and a large workload is placed on the user.

Under the circumstances described above, there is a demand for a technique capable of reducing the workload on a user of a machine tool who selects specific one axis to be oscillated during machining.

### Means for Solving the Problems

A first aspect of the present disclosure is directed to an information processing device including: an oscillation axis selection unit that selects, from among a plurality of feed axes, one specific axis as an oscillation axis for oscillating cutting that is performed by oscillating only one specific axis, or abstains from selecting any of the plurality of feed axes as an axis to be oscillated, based on tool shape data allowing for recognizing a tool shape, positional relationship data indicating a positional relationship between a workpiece and a tool, or tool-for-use data allowing for identifying a tool to be used, and movement data allowing for relatively moving the workpiece and the tool; and an output unit that outputs a result of selection by the oscillation axis selection unit.

A second aspect of the present disclosure is directed to a machine tool control device for a machine tool that performs oscillating cutting by oscillating only one specific axis. The machine tool control device includes: an oscillation axis selection unit that selects, from among a plurality of feed axes, one specific axis as an oscillation axis for oscillating cutting that is performed by oscillating only one specific axis, or abstains from selecting any of the plurality of feed axes as an axis to be oscillated, based on tool shape data allowing for recognizing a tool shape, positional relationship data indicating a positional relationship between a workpiece and a tool, or tool-for-use data allowing for identifying a tool to be used, and movement data allowing for relatively moving the workpiece and the tool; and an oscillation control unit that performs control to oscillate the one specific axis selected by the oscillation axis selection unit or control not to oscillate any of the feed axes, based on a machining condition and a result of selection by the oscillation axis selection unit.

A third aspect of the present disclosure is directed to a computer program for causing a computer to execute steps that include: an oscillation axis selection step of selecting, from among a plurality of feed axes, one specific axis as an oscillation axis for oscillating cutting that is performed by oscillating only one specific axis, or abstaining from selecting any of the plurality of feed axes as an axis to be oscillated, based on tool shape data allowing for recognizing a tool shape, positional relationship data indicating a positional relationship between a workpiece and a tool, or tool-for-use data allowing for identifying a tool to be used, and movement data allowing for relatively moving the workpiece and the tool; and an output step of outputting a result of selection made in the oscillation axis selection step.

The present disclosure make is possible to reduce the workload on a user of a machine tool who selects specific one axis to be oscillated during machining.

### BRIEF DESCRIPTION OF THE DRAWINGS

FIG. 1 is a diagram illustrating a machine tool control device according to an embodiment of the present disclosure;

FIG. 2 is a diagram illustrating movement directions 1 to 8 of a tool;

FIG. 3 is a diagram illustrating cutting edge directions A to H of tools;

FIG. 4 is a diagram illustrating a tool with the cutting edge direction C;

FIG. 5 is a diagram illustrating a tool with the cutting edge direction H;

FIG. 6 illustrates positional relationship data between a workpiece and a tool;

FIG. 7 is a diagram illustrating external turning performed on a workpiece;

FIG. 8 is a diagram illustrating internal turning performed on a workpiece;

FIG. 9 is a diagram illustrating cutting in a case where a tool is moved in the movement direction 2;

FIG. 10 is a diagram illustrating cutting in a case where a tool is moved in the movement direction 3;

FIG. 11 is a diagram illustrating cutting in a case where a tool has the cutting edge direction C and is moved in the movement direction 2;

FIG. 12 is a diagram illustrating a Z-axis oscillation and an X-axis oscillation in the cutting illustrated in FIG. 11;

FIG. 13 is a diagram illustrating cutting in a case where a tool has the cutting edge direction H and is moved in the movement direction 3;

FIG. 14 is a diagram illustrating a Z-axis oscillation and an X-axis oscillation in the cutting illustrated in FIG. 13;

FIG. 15 is a diagram illustrating selection of an oscillation axis that allows for shredding chips, based on a cutting edge direction and a movement direction of a tool;

FIG. 16 is a diagram illustrating a case in which an oscillation is stopped upon a determination that there is no oscillation axis that allows for shredding chips based on a cutting edge direction and a movement direction of a tool;

FIG. 17 is a diagram illustrating external turning in a case where a tool shape is unknown;

FIG. 18 is a diagram illustrating internal turning in a case where a tool shape is unknown;

FIG. 19 is a diagram illustrating external turning in a case where a tool is moved in the movement direction 2;

FIG. 20 is a diagram illustrating internal turning in a case where a tool is moved in the movement direction 3;

FIG. 21 is a diagram illustrating a Z-axis oscillation and an X-axis oscillation in a case of external turning performed using a tool which is moved in the movement direction 2, the tool shape (cutting edge direction) of which is unknown, and which has the cutting edge direction D;

FIG. 22 is a diagram illustrating a Z-axis oscillation and an X-axis oscillation in a case of external turning performed using a tool which is moved in the movement direction 2, the tool shape (cutting edge direction) of which is unknown, and which has the cutting edge direction H;

FIG. 23 is a diagram illustrating a Z-axis oscillation and an X-axis oscillation in a case of external turning performed using a tool which is moved in the movement direction 2, the tool shape (cutting edge direction) of which is unknown, and which has the cutting edge direction B;

FIG. 24 is a diagram illustrating a Z-axis oscillation and an X-axis oscillation in a case of external turning performed using a tool which is moved in the movement direction 2, the tool shape (cutting edge direction) of which is unknown, and which has the cutting edge direction G;

FIG. 25 is a diagram illustrating a Z-axis oscillation and an X-axis oscillation in a case of external turning performed using a tool which is moved in the movement direction 2, the tool shape (cutting edge direction) of which is unknown, and which has the cutting edge direction C;

FIG. 26 is a diagram illustrating a Z-axis oscillation and an X-axis oscillation in a case of internal turning performed using a tool which is moved in the movement direction 3, the tool shape (cutting edge direction) of which is unknown, and which has the cutting edge direction C;

FIG. 27 is a diagram illustrating a Z-axis oscillation and an X-axis oscillation in a case of internal turning performed using a tool which is moved in the movement direction 3, the tool shape (cutting edge direction) of which is unknown, and which has the cutting edge direction G;

FIG. 28 is a diagram illustrating a Z-axis oscillation and an X-axis oscillation in a case of internal turning performed using a tool which is moved in the movement direction 3, the tool shape (cutting edge direction) of which is unknown, and which has the cutting edge direction B;

FIG. 29 is a diagram illustrating a Z-axis oscillation and an X-axis oscillation in a case of internal turning performed using a tool which is moved in the movement direction 3, the tool shape (cutting edge direction) of which is unknown, and which has the cutting edge direction F;

FIG. 30 is a diagram illustrating a Z-axis oscillation and an X-axis oscillation in a case of internal turning performed using a tool which is moved in the movement direction 3, the tool shape (cutting edge direction) of which is unknown, and which has the cutting edge direction A;

FIG. 31 is a diagram illustrating tools of tool numbers Nos. 1 to 3; and

FIG. 32 is a diagram illustrating an example of conventional oscillating cutting.

### PREFERRED MODE FOR CARRYING OUT THE INVENTION

Embodiments of the present disclosure will be described in detail with reference to the drawings.

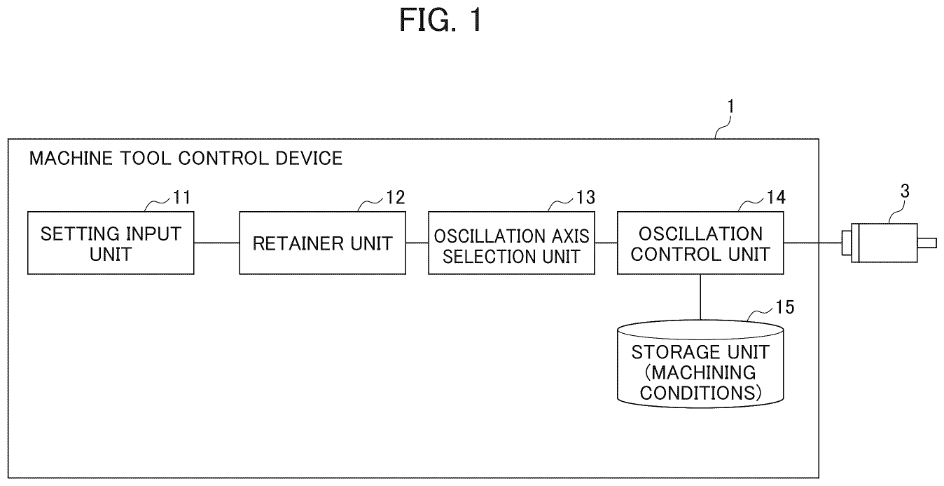

FIG. 1 is a diagram illustrating a machine tool control device 1 according to the present embodiment. The machine tool control device 1 of the present embodiment operates at least one spindle that relatively rotates a cutting tool (hereinafter referred to as the tool) and a workpiece, and at least one feed shaft that moves the tool relative to the workpiece, thereby cutting the workpiece using the tool. In FIG. 1, for the sake of convenience, only the motor 3 for driving one feed shaft is illustrated.

The machine tool control device 1 according to the present embodiment performs oscillating cutting by operating the spindle and the feed shaft. Specifically, the machine tool control device 1 performs cutting by relatively oscillating the tool and the workpiece while relatively rotating the tool and the workpiece. The tool path, which is the path along which the tool is moved, is set so that a current pass partially overlaps with a previous pass, and a portion machined in the previous pass is included in a portion machined in the current pass. As a result, air cutting, i.e., a phenomenon in which the cutting edge of the tool separates from the surface of the workpiece, takes place, so that chips continuously generated by cutting are reliably shredded.

In the oscillating cutting performed according to the present embodiment, the shape of the workpiece is not limited. That is, the present embodiment is applicable to not only a case where the workpiece has a tapered portion or an arc-shaped portion on its surface to be machined and a plurality of feed axes (the Z-axis and the X-axis) are necessary, but also a case where the workpiece has a cylindrical or circular columnar shape and one specific axis (Z-axis) is sufficient for the machining.

The machine tool control device 1 is constituted by, for example, a computer including a memory such as a read only memory (ROM) or a random access memory (RAM), a central processing unit (CPU), and a communication control unit that are connected to each other via a bus. As illustrated in FIG. 1, the machine tool control device 1 includes a setting input unit 11, a retainer unit 12, an oscillation axis selection unit 13, an oscillation control unit 14, and a storage unit 15. Functions and operations of these units can be implemented by cooperation of the CPU, the memory, and a control program stored in the memory.

The machine tool control device 1 is connected to a host computer (not shown) such as a computer numerical controller (CNC), a programmable logic controller (PLC), etc. These host computers input, in addition to a machining program, machining conditions including a rotation speed, a feed rate, etc., and oscillation conditions including an oscillation amplitude, an oscillation frequency, etc. to the machine tool control device 1.

The setting input unit 11 sets and inputs predetermination results indicating that one specific axis should be selected, from among a plurality of feed axes, as an oscillation axis for oscillating cutting that is performed by oscillating only one specific axis, or indicating that none of the plurality of feed axes should be selected as an axis to be oscillated, for each of combinations of tool shape data and movement data, combinations of positional relationship data and the movement data, and combinations of tool-for-use data and the movement data. The setting input unit 11 sets and inputs the predetermination results in accordance with, for example, an operation by a user.

The retainer unit 12 retains the predetermination results indicating that one specific axis should be selected, from among the plurality of feed axes, as the oscillation axis for oscillating cutting that is performed by oscillating only one specific axis, or indicating that none of the plurality of feed axes should be selected as the axis to be oscillated, for each of the combinations of the tool shape data and the movement data, the combinations of the positional relationship data and the movement data, and the combinations of the tool-for-use data and the movement data. That is, the retainer unit 12 retains the predetermination results inputted from the setting input unit 11.

Next, the movement data, the tool shape data, the positional relationship data, and the tool-for-use data will be described in detail.

The movement data is data that allows for relatively moving the workpiece and the tool. Specifically, the movement data can be obtained from a machining program inputted from the above-described host computer. However, the source of the movement data is not limited to the machining program, and any data may be used provided that the movement data such as machining conditions inputted to the machine tool control device 1 can be obtained from the data. A movement direction of the tool can be obtained from the movement data.

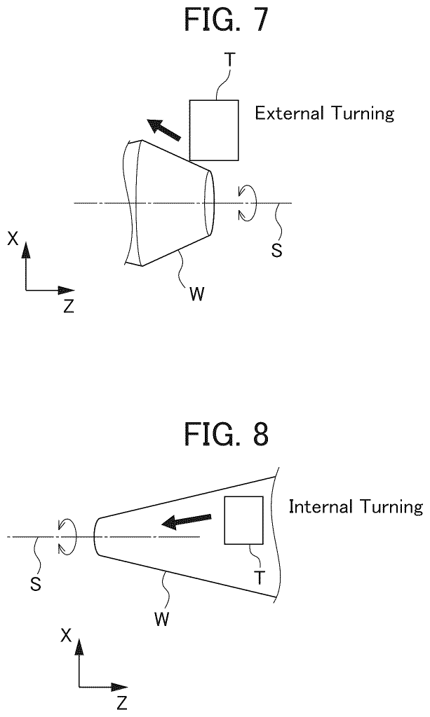

As illustrated in FIG. 7 and the subsequent figures to be described later, the present embodiment will be described on an assumption that cutting is performed by moving the tool T by means of a feed shaft with respect to the workpiece W being rotated by the spindle S. A central axis of the workpiece W is defined as a Z-axis, and a direction orthogonal to the Z-axis is defined as an X-axis. However, the present embodiment is not limited thereto, and a configuration may be adopted in which cutting is performed by rotating the tool T around the central axis of the workpiece W and moving the workpiece W in a feed direction with respect to the tool T.

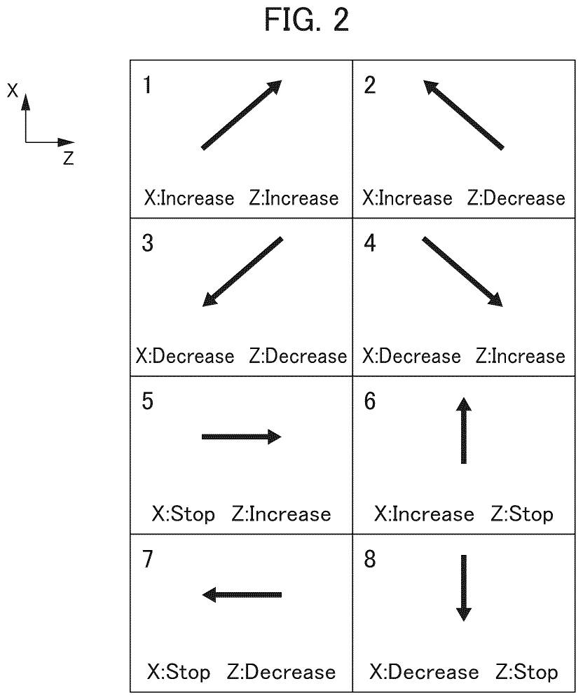

FIG. 2 is a diagram illustrating movement directions 1 to 8 of the tool T. As illustrated in FIG. 2, the tool T is movable in the eight different movement directions. Specifically, the eight movement directions 1 to 8 of the tool T are classified according to a combination of an increase/decrease in an X-axis coordinate value and an increase/decrease in a Z-axis coordinate value. The movement direction 1 is a direction in which both the X-axis coordinate value and the Z-axis coordinate value increase. The movement direction 2 is a direction in which the X-axis coordinate value increases whereas the Z-axis coordinate value decreases. The movement direction 3 is a direction in which both the X-axis coordinate value and the Z-axis coordinate value decrease. The movement direction 4 is a direction in which the X-axis coordinate value decreases whereas the Z-axis coordinate value increases. The movement direction 5 is a direction in which the X-axis coordinate value is constant (stop) whereas the Z-axis coordinate value increases. The movement direction 6 is a direction in which the X-axis coordinate value increases whereas the Z-axis coordinate value is constant (stop). The movement direction 7 is a direction in which the X-axis coordinate value is constant (stop) whereas the Z-axis coordinate value decreases. The movement direction 8 is a direction in which the X-axis coordinate value decreases whereas the Z-axis coordinate value is constant (stop). As can be seen, the tool T is moved in any one of the movement directions 1 to 8.

The tool shape data is data that allows for recognizing the tool shape. Specifically, the tool shape data can be obtained from, for example, a machining program inputted from the above-described host computer. The tool shape data includes at least information indicating a cutting edge direction of the tool T, and a cutting angle of the tool T and the like. The cutting angle of the tool T is an angle between the Z-axis direction, which is the central axis direction of the workpiece W, and a relief surface of the tool T. The relief surface refers to a surface of the cutting edge of the tool T that is adjacent to the workpiece W and directed in a machining direction. The cutting angle is set in advance to a desired angle for each of a plurality of tools T.

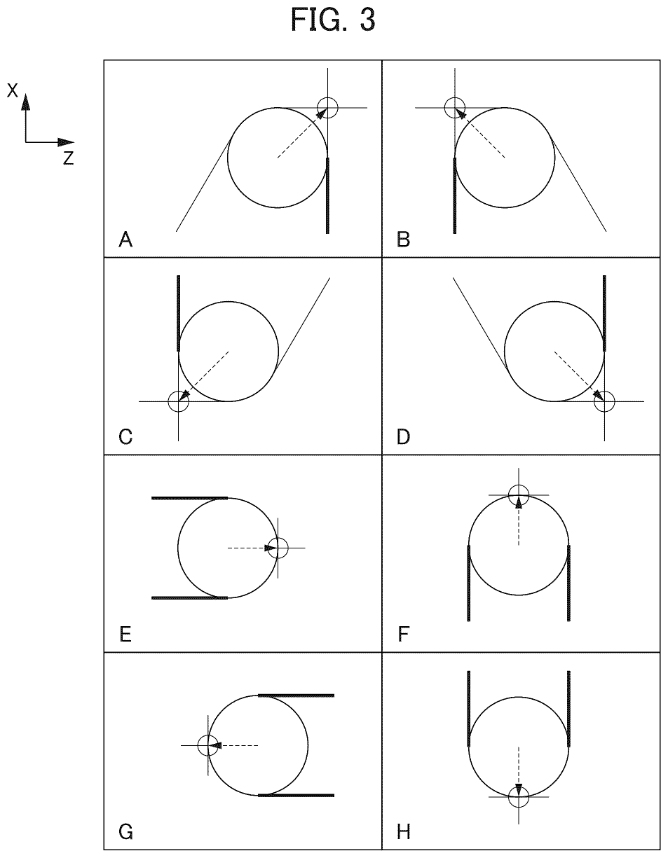

FIG. 3 is a diagram illustrating cutting edge directions A to H of the tool T. As illustrated in FIG. 3, there are eight different cutting edge directions for tools T. Specifically, the cutting edge directions A to H of the tools T correspond to the movement directions 1 to 8 of the tools T. Specifically, for the tools T, the cutting edge direction A corresponds to the movement direction 1, the cutting edge direction B corresponds to the movement direction 2, the cutting edge direction C corresponds to the movement direction 3, and the cutting edge direction D corresponds to the movement direction 4. For the tools T, the cutting edge direction E corresponds to the movement direction 5, the cutting edge direction F corresponds to the movement direction 6, the cutting edge direction G corresponds to the movement direction 7, and the cutting edge direction H corresponds to the movement direction 8. Thus, the cutting edge of the tool T is directed in any one of the cutting edge directions A to H.

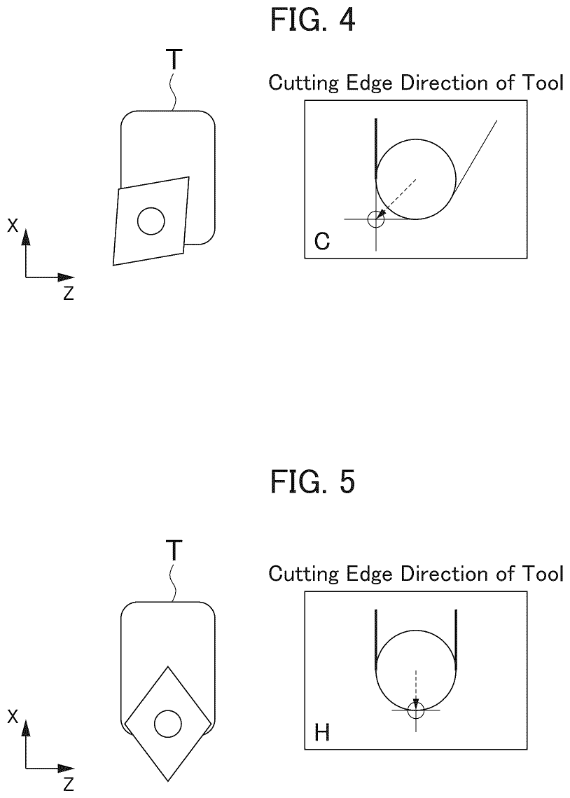

FIG. 4 is a diagram illustrating a tool T having the cutting edge direction C. FIG. 5 is a diagram illustrating a tool T having the cutting edge direction H. As illustrated in these figures, the eight cutting edge directions can be set for the tools T. The cutting edge direction of the tool T has a significant influence on whether or not chips can be shredded during oscillating cutting. Therefore, the cutting edge direction of the tool T serves as a base on which a determination is made as to whether or not chips can be shredded.

The positional relationship data is data indicating a positional relationship between a workpiece W and a tool T. Specifically, the positional relationship data can be obtained from, for example, a machining program inputted from the above-described host computer. From the positional relationship data, information can be obtained which indicates whether external turning or internal turning is to be performed.

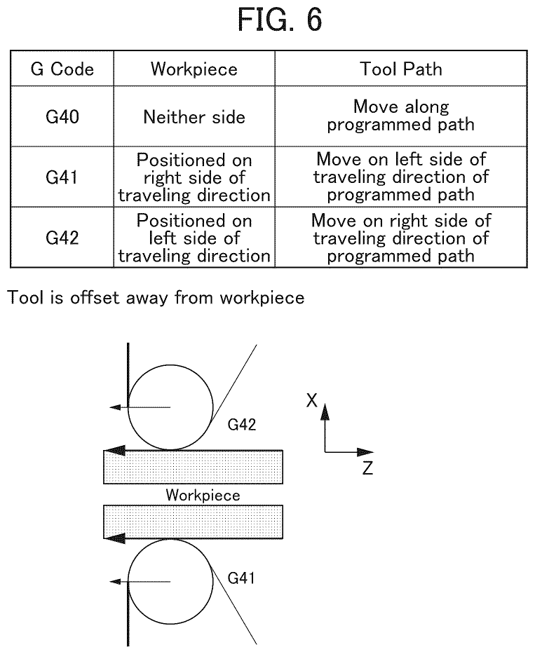

FIG. 6 illustrates positional relationship data between a workpiece W and a tool T. G40, G41, and G42 shown in FIG. 6 are G codes relating to tool nose radius compensation, and the positional relationship between the workpiece W and the tool T can be obtained from these G codes. Specifically, G40 is a G code indicating tool nose radius compensation cancel, and in this case, the tool T moves along a programmed path. On the other hand, G41 is a G code indicating tool nose radius compensation left, and in this case, as can be seen from FIG. 6, the tool T is offset-compensated with respect to the programmed path away from the workpiece W by a command value, so that the tool T moves on the left side of the traveling direction, whereas the workpiece W is positioned on the right side of the traveling direction. G42 is a G code indicating tool nose radius compensation right, and in this case, as can be seen from the figure, the tool T is offset-compensated with respect to the programmed path away from the workpiece W by a command value, so that the tool T moves on the right side of the traveling direction, whereas the workpiece W is positioned on the left side of the traveling direction.

Accordingly, for example, the positional relationship data between the workpiece W and the tool T can be obtained from the G code contained in a machining program inputted to the machine tool control device 1. Specifically, in a case where the G code is G41, positional relationship data indicating the internal turning illustrated in FIG. 8 is obtained as the positional relationship between the workpiece W and the tool T. In a case where the G code is G42, positional relationship data indicating the external turning illustrated in FIG. 7 is obtained as the positional relationship between the workpiece W and the tool T.

The tool-for-use data is data that allows for identifying a tool to be used. Specifically, the tool-for-use data is, for example, data indicating the tool number of a tool to be used. The tool-for-use data can be obtained from, for example, a machining program inputted from the above-described host computer.

Next, the above-described predetermination results, which are inputted by the setting input unit 11 and retained by the retainer unit 12, will be described in detail.

As described above, the predetermination results indicates that one specific axis should be selected, from among a plurality of feed axes, as the oscillation axis for oscillating cutting that is performed by oscillating only one specific axis, or indicating that none of the plurality of feed axes should be selected as an axis to be oscillated. The predetermination results are obtained through predetermination made for each of the combinations of the tool shape data and the movement data, the combinations of the positional relationship data and the movement data, and the combinations of the tool-for-use data and the movement data.

Furthermore, the predetermination results are based on whether or not chips that are continuously generated can be shredded. That is, the predetermination results are obtained by determining in advance whether or not chips can be shredded for each of the combinations of the tool shape data and the movement data, the combinations of the positional relationship data and the movement data, and the combinations of the tool-for-use data and the movement data, and indicate, based on the result of this determination, one specific axis should be selected, from among a plurality of feed axes, as the oscillation axis for oscillating cutting that is performed by oscillating only one specific axis, or that none of the plurality of feed axes should be selected as an axis to be oscillated.

Here, the determination as to whether or not chips can be shredded is influenced by oscillation conditions including an oscillation amplitude, an oscillation frequency, etc. Therefore, in a case of making the determination as to whether or not chips can be shredded, it is determined whether or not chips can be shredded if one specific axis is oscillated at an arbitrary oscillation amplitude. Specifically, for example, in a case where chips can be shredded at an arbitrary oscillation amplitude, it is determined that shredding of chips is possible, whereas in a case where an oscillation amplitude allowing for shredding chips is not found even if the oscillation amplitude is varied, it is determined that shredding of chips is impossible.

The predetermination results are set and inputted by the setting input unit 11 and retained by the retainer unit 12 in the form of table data, for example. Specifically, the table data includes: table data indicating predetermination results corresponding to the combinations of the tool shape data and the movement data (see Table 1 described later); table data indicating predetermination results corresponding to the combinations of the positional relationship data and the movement data (see Table 2 described later); and table data indicating predetermination results corresponding to the combinations of the tool-for-use data and the movement data (see Table 3 described later). However, the predetermination results do not necessarily have to be provided in the table data format, and may be provided in any data format.

Referring back to FIG. 1, the oscillation axis selection unit 13 selects one specific axis as the oscillation axis or abstains from selecting any axis as the axis to be oscillated, based on the predetermination results retained by the retainer unit 12. That is, the oscillation axis selection unit 13 is capable of automatically selecting one specific axis to be oscillated or automatically abstaining from selecting any axis as the axis to be oscillated, based on the predetermination results retained by the retainer unit 12.

Thus, for example, the oscillation axis selection unit 13 can select one specific axis that has a highest probability of shredding chips as the oscillation axis. The highest probability of shredding chips is not limited to a 100% probability of shredding, but includes a probability less than 100%. Alternatively, the oscillation axis selection unit 13 can abstain from selecting any axis as the axis to be oscillated in a case where there is no axis allowing for shredding chips, or in a case where the probability of shredding chips is not 100%. The selection of the oscillation axis by the oscillation axis selection unit 13 will be described in detail later.

The storage unit 15 stores machining conditions and the like of the workpiece W. The machining conditions of the workpiece W include, for example, a relative rotation speed of the workpiece W and the tool T around the central axis of the workpiece W, a relative feed rate of the tool T and the workpiece W, and a position command for a feed axis. The storage unit 15 may store a machining program to be executed by the machine tool, and the CPU in the machine tool control device 1 may read the rotation speed and the feed rate from the machining program as machining conditions and may output them to the oscillation control unit 14. The storage unit 15 and a position command generation unit in the oscillation control unit 14, which will be described later, may be provided in the above-described host computer.

The oscillation control unit 14 performs control to oscillate one specific axis selected by the oscillation axis selection unit 13 or control not to oscillate any of the feed axes, based on the machining conditions and the result of selection by the oscillation axis selection unit 13. In order to control the oscillation, the oscillation control unit 14 includes, for example, various functional units (none of which is shown) such as a position command generation unit, an oscillation command generation unit, a superimposition command generation unit, a learning control unit, and a position/speed control unit.

The position command generation unit reads the machining conditions stored in the storage unit 15, and generates a position command as a movement command for the motor 3 based on the machining conditions. Specifically, the position command generation unit generates position commands (movement commands) for the respective feed axes based on the relative rotation speed of the workpiece W and the tool T around the central axis of the workpiece W and the relative feed rate of the tool T and the workpiece W.

The oscillation command generation unit generates an oscillation command. The oscillation command generation unit may generate the oscillation command from machining conditions and oscillation conditions including an oscillation amplitude multiplying factor and an oscillation frequency multiplying factor, or may generate the oscillation command from oscillation conditions including an oscillation amplitude and an oscillation frequency. Specifically, the oscillation command generation unit generates the oscillation command based on the oscillation conditions including the oscillation amplitude, the oscillation frequency, etc., which are inputted from the host computer and stored in the storage unit 15.

The superimposition command generation unit calculates a position deviation which is a difference between the position command and position feedback that is based on position detection by an encoder of the motor 3 of the feed shaft, and superimposes the oscillation command generated by the oscillation command generation unit on the calculated position deviation, thereby generating a superposition command. Alternatively, the superimposition command generation unit may superimpose the oscillation command on the position command instead of the position deviation.

The learning control unit calculates a correction amount for the superimposition command based on the superimposition command, and corrects the superimposition command by adding the calculated correction amount to the superimposition command. The learning control unit has a memory and stores, in the memory, oscillation phases and correction amounts in association with each other in one or a plurality of cycles of oscillation. The learning control unit reads a superimposition command stored in the memory at a timing at which a phase delay of oscillation according to the responsiveness of the motor 3 can be compensated, and outputs the superimposition command as a correction amount. In a case where none of the oscillation phases stored in the memory is associated with a correction amount to be outputted, the learning control unit may calculate the correction amount to be outputted based on a correction amount associated with a close oscillation phase. In general, a position deviation with respect to an oscillation command increases as an oscillation frequency increases. For this reason, the correction performed by the learning control unit makes it possible to improve the followability to a periodic oscillation command.

The position/speed control unit generates a torque command for the motor 3 that drives the feed shaft based on the superimposition command to which the correction amount has been added, and controls the motor 3 based on the generated torque command. Thus, machining is performed while the tool T and the workpiece W are relatively oscillated.

Next, the selection of an oscillation axis by the oscillation axis selection unit 13 will be described in detail.

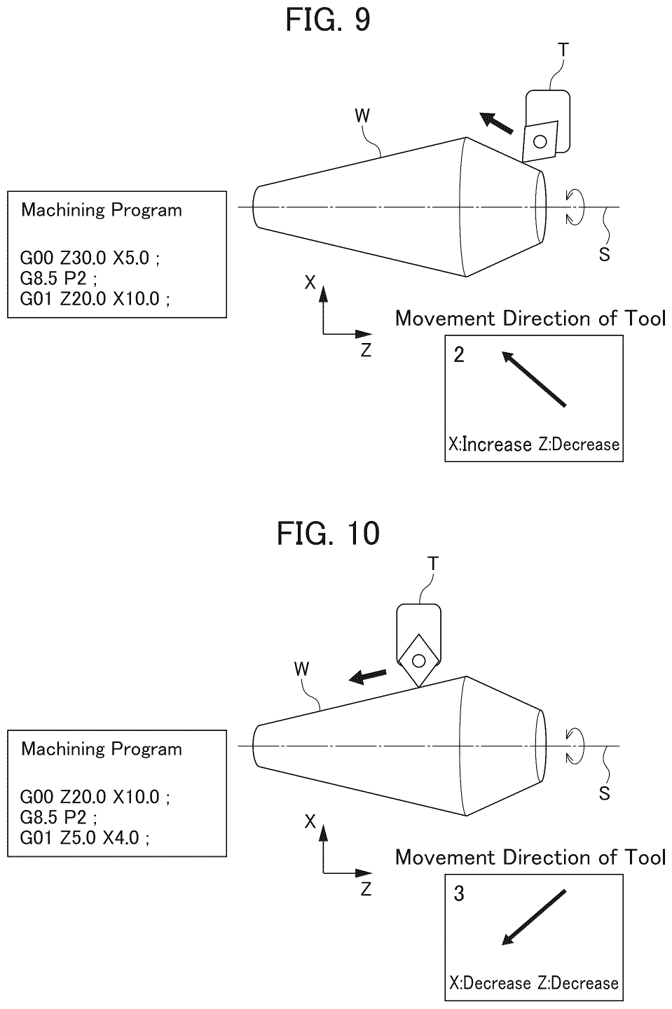

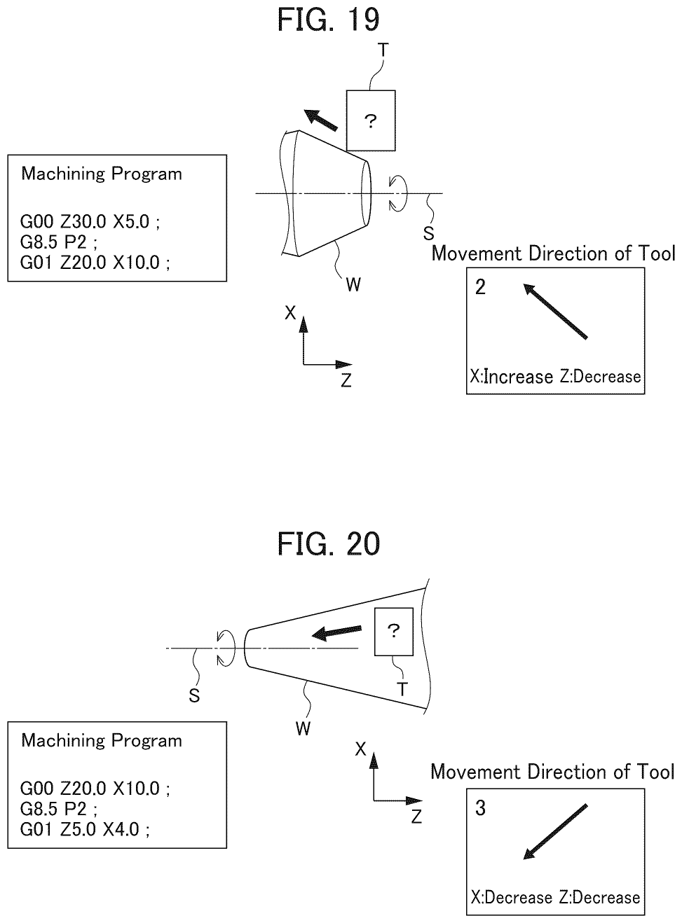

First, a case where the oscillation axis is selected with reference to results of a predetermination made based on the tool shape data and the movement data will be described in detail with reference to FIGS. 9 to 16. As specific examples, the cutting illustrated in FIG. 9 in which the tool T is moved in the movement direction 2 and the cutting illustrated in FIG. 10 in which the tool T is moved in the movement direction 3 will be described. FIGS. 9 and 10 show, in addition to the movement direction of the tool T, a machining program that is executed in the respective example (the same applies to FIGS. 19 and 20 described later).

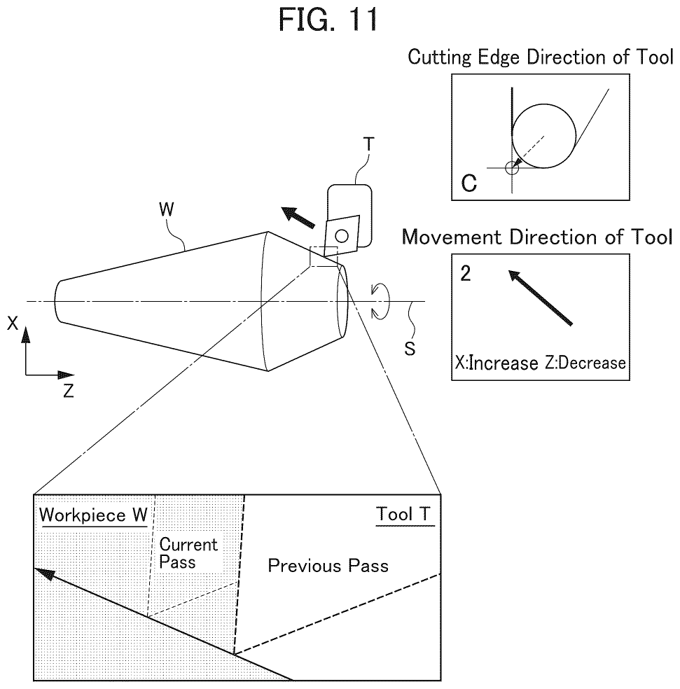

FIG. 11 is a diagram illustrating cutting in which the tool T has the cutting edge direction C and is moved in the movement direction 2. That is, FIG. 11 illustrates the case in which the cutting in the movement direction 2 illustrated in FIG. 9 is performed by the tool T having the cutting edge direction C. The enlarged diagram in FIG. 11 illustrates a previous pass and a current pass of the tool T in a case the tool T is not oscillated.

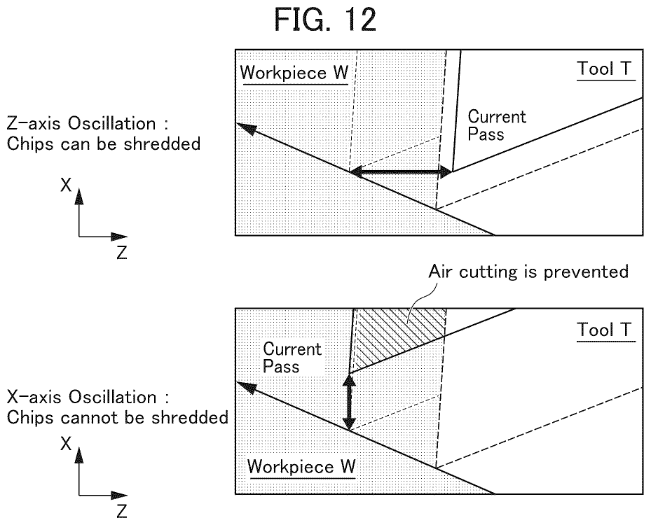

FIG. 12 is a diagram illustrating a Z-axis oscillation and an X-axis oscillation in the cutting illustrated in FIG. 11. As illustrated in FIG. 12, in the case of the cutting by the tool having the cutting edge direction C and being moved in the movement direction 2, when the tool T is oscillated in the Z-axis direction, the current pass of the cutting edge of the tool T is included in the previous pass, and the cutting edge of the tool T is moved to a position separated from the surface of the workpiece W, so that air cutting takes place, and chips can be shredded. In contrast, when the tool T is oscillated in the X-axis direction, the current pass of the cutting edge of the tool T is not included in the previous pass, and the cutting edge of the tool T can be moved only on the workpiece W, so that air cutting does not take place, and chips cannot be shredded.

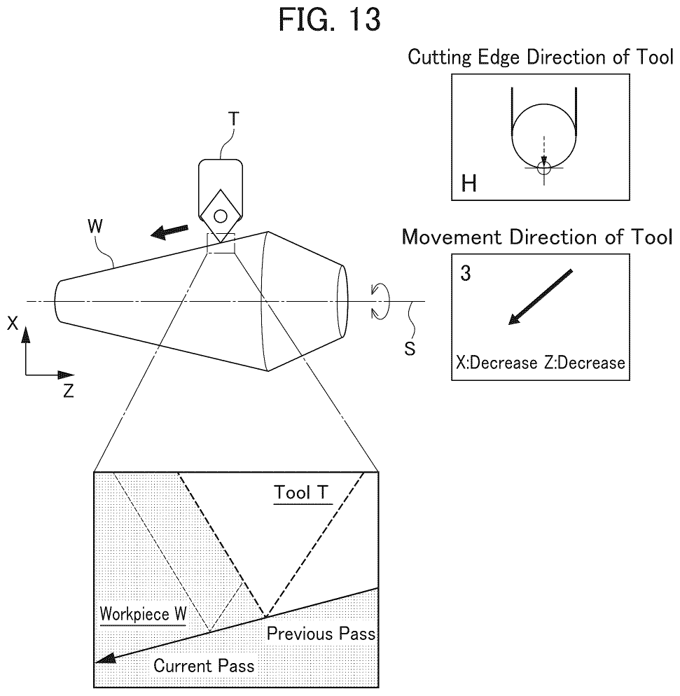

FIG. 13 is a diagram illustrating cutting in which the tool T has the cutting edge direction H and is moved in the movement direction 3. That is, FIG. 13 illustrates the case in which the cutting in the movement direction 3 illustrated in FIG. 10 is performed by the tool T having the cutting edge direction H. The enlarged diagram in FIG. 13 illustrates a previous pass and a current pass of the tool T in a case the tool T is not oscillated.

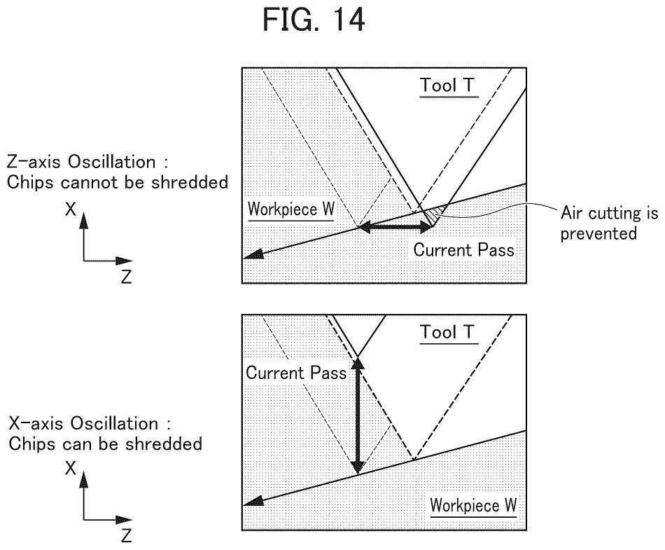

FIG. 14 is a diagram illustrating a Z-axis oscillation and an X-axis oscillation in the cutting illustrated in FIG. 13. As illustrated in FIG. 14, in the case of the cutting by the tool having the cutting edge direction H and being moved in the movement direction 3, when the tool T is oscillated in the Z-axis direction, the current pass of the cutting edge of the tool T is not included in the previous pass, and the cutting edge of the tool T can be moved only on the workpiece W, so that air cutting does not take place, and chips cannot be shredded. In contrast, when the tool T is oscillated in the X-axis direction, the current pass of the cutting edge of the tool T is included in the previous pass, and the cutting edge of the tool T is moved to a position separated from the surface of the workpiece W, so that air cutting takes place, and chips can be shredded.

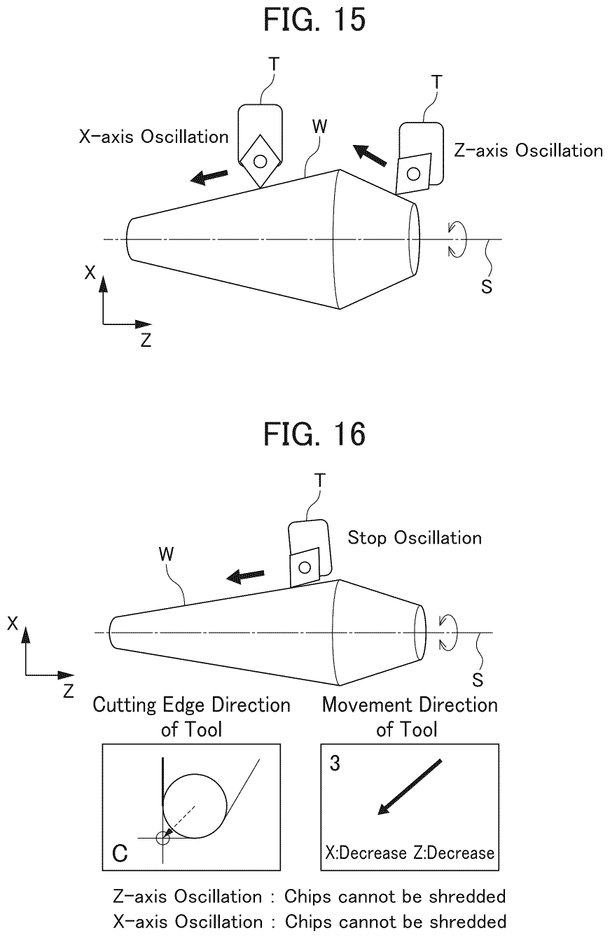

Thus, in the case of the cutting by the tool having the cutting edge direction C and being moved in the movement direction 2, chips can be shredded by way of the oscillation in the Z-axis direction. Therefore, the oscillation axis selection unit 13 selects the Z-axis as the oscillation axis based on the predetermination result indicating that the Z-axis should be selected as the oscillation axis. On the other hand, in the case of the cutting by the tool having the cutting edge direction H and being moved in the movement direction 3, chips can be shredded by way of the oscillation in the X-axis direction. Therefore, the oscillation axis selection unit 13 selects the X-axis as the oscillation axis based on the predetermination result indicating that the X-axis should be selected as the oscillation axis. FIG. 15 is a diagram illustrating selection of an oscillation axis that allows for shredding chips, based on the cutting edge direction and the movement direction of the tool T.

FIG. 16 is a diagram illustrating a case in which an oscillation is stopped upon a determination that there is no oscillation axis that allows for shredding chips based on a cutting edge direction and a movement direction of the tool T. As illustrated in FIG. 16, in the case where the tool T has the cutting edge direction C and is moved in the movement direction 3, chips cannot be shredded by oscillating the tool T in the Z-axis direction or in the X-axis direction. Therefore, based on the predetermination result indicating that neither axis should be selected as the axis to be oscillated, the oscillation axis selection unit 13 does not select any axis as the oscillation axis, and as a result, stops the oscillation.

The predetermination results obtained in the above-described manner are set and inputted by the setting input unit 11 and retained by the retainer unit 12, in the form of table data of the predetermination results obtained for the combinations of the tool shape data and the movement data, as shown in Table 1. Thus, based on the table data of the predetermination results shown in Table 1, the oscillation axis selection unit 13 executes processing of selecting, from among the plurality of feed axes, one specific axis as the oscillation axis for oscillating cutting that is performed by oscillating only one specific axis, or processing of abstaining from selecting any axis as the axis to be oscillated.

TABLE 1

| | A | B | C | D | E | F | G | H |
|---|---|---|---|---|---|---|---|---|
| 1 | ~ | ~ | ~ | ~ | ~ | ~ | ~ | ~ |
| 2 | ~ | ~ | Z-axis | ~ | ~ | ~ | ~ | ~ |
| | | | Oscillation | | | | | |
| 3 | ~ | ~ | No | ~ | ~ | ~ | ~ | X-axis |
| | | | Oscillation | | | | | Oscillation |
| 4 | ~ | ~ | ~ | ~ | ~ | ~ | ~ | ~ |
| 5 | ~ | ~ | ~ | ~ | ~ | ~ | ~ | ~ |
| 6 | ~ | ~ | ~ | ~ | ~ | ~ | ~ | ~ |
| 7 | ~ | ~ | ~ | ~ | ~ | ~ | ~ | ~ |
| 8 | ~ | ~ | ~ | ~ | ~ | ~ | ~ | ~ |

In Table 1, 1 to 8 represent the movement directions 1 to 8 of the tool T illustrated in FIG. 2, and A to H represent the cutting edge directions A to H of the tool T illustrated in FIG. 3. The sign “˜” in Table 1 indicates omission of a description for the sake of convenience. Actually, a predetermination result indicating an oscillation axis or no oscillation is written in each cell. The same applies to Tables 2 and 3, which will be described later.

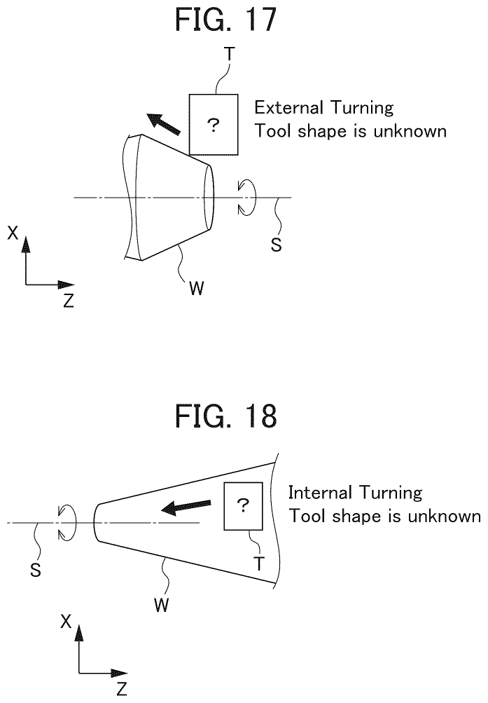

Next, a case where the oscillation axis is selected with reference to results of a predetermination made based on the movement data and data of a positional relationship between the workpiece W and the tool T, i.e., data indicating whether external turning or internal turning is performed will be described in detail with reference to FIGS. 17 to 30. As specific examples, the external turning illustrated in FIG. 17 in which a tool shape (cutting edge direction) of a tool T is unknown and the tool T is moved in the movement direction 2 illustrated in FIG. 19, and the internal turning illustrated in FIG. 18 in which a tool shape (cutting edge direction) of a tool T is unknown and the tool T is moved in the movement direction 3 illustrated in FIG. 20 will be described.

Here, in the case of external turning performed using a tool T being moved in the movement direction 2, the tool T can have one of the five cutting edge directions D, H, B, G, and C from among the cutting edge directions A to H. That is, in the external turning performed using the tool T being moved in the movement direction 2, it is impractical for the tool T to have any of the three cutting edge directions A, E, and F from the viewpoint of interference between the workpiece W and the tool T.

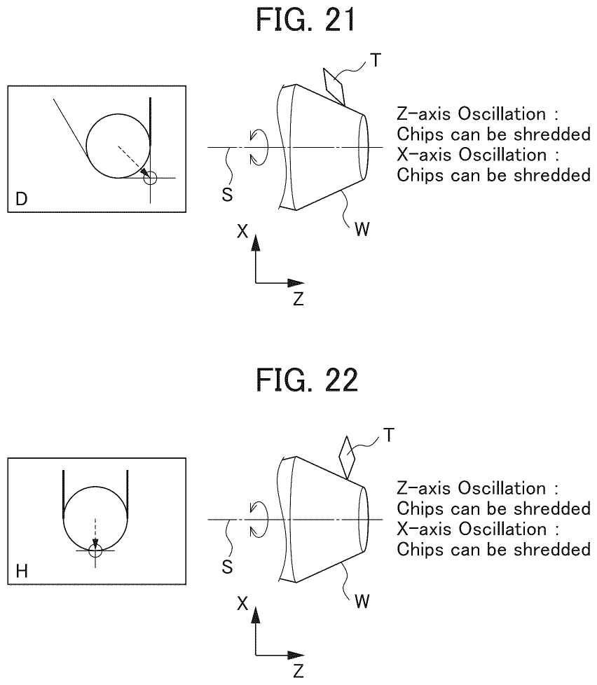

FIG. 21 is a diagram illustrating a Z-axis oscillation and an X-axis oscillation in a case of external turning performed using a tool T which is moved in the movement direction 2, the tool shape (cutting edge direction) of which is unknown, and which has the cutting edge direction D. In this case, as illustrated in FIG. 21, chips can be shredded by either of the Z-axis oscillation and the X-axis oscillation.

FIG. 22 is a diagram illustrating a Z-axis oscillation and an X-axis oscillation in a case of external turning performed using a tool T which is moved in the movement direction 2, the tool shape (cutting edge direction) of which is unknown, and which has the cutting edge direction H. In this case, as illustrated in FIG. 22, chips can be shredded by either of the Z-axis oscillation and the X-axis oscillation.

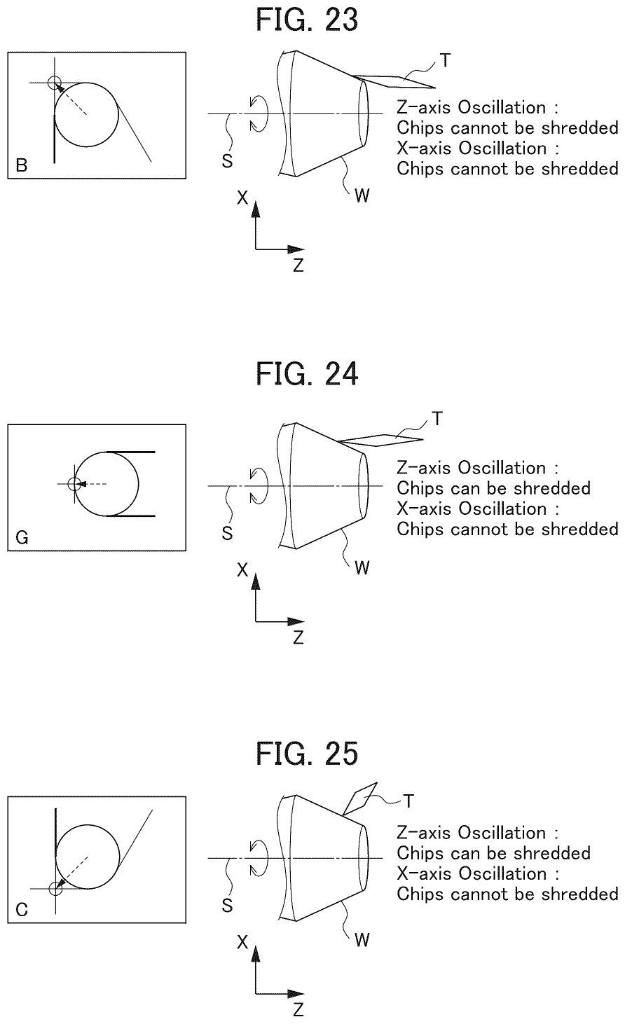

FIG. 23 is a diagram illustrating a Z-axis oscillation and an X-axis oscillation in a case of external turning performed using a tool T which is moved in the movement direction 2, the tool shape (cutting edge direction) of which is unknown, and which has the cutting edge direction B. In this case, as illustrated in FIG. 23, chips cannot be shredded by the Z-axis oscillation or the X-axis oscillation.

FIG. 24 is a diagram illustrating a Z-axis oscillation and an X-axis oscillation in a case of external turning performed using a tool T which is moved in the movement direction 2, the tool shape (cutting edge direction) of which is unknown, and which has the cutting edge direction G. In this case, as illustrated in FIG. 24, chips can be shredded by the Z-axis oscillation, but cannot be shredded by the X-axis oscillation.

FIG. 25 is a diagram illustrating a Z-axis oscillation and an X-axis oscillation in a case of external turning performed using a tool T which is moved in the movement direction 2, the tool shape (cutting edge direction) of which is unknown, and which has the cutting edge direction C. In this case, as illustrated in FIG. 25, chips can be shredded by the Z-axis oscillation, but cannot be shredded by the X-axis oscillation.

The above-described results of predetermination on shredding of chips illustrated in FIGS. 21 to 25 show that in the case of external turning performed using a tool T which is moved in the movement direction 2 and the cutting edge direction of which is unknown, when chips can be shredded by the X-axis oscillation, they can be shredded by the Z-axis oscillation as well. That is, it is appreciated that in this case, the probability (percentage) of shredding chips is higher when the Z-axis oscillation is generated than when the X-axis oscillation is generated. Therefore, in the case of external turning performed using a tool T which is moved in the movement direction 2 and the tool shape of which is unknown, a predetermination is made that the Z-axis having a higher probability of shredding chips should be selected as the oscillation axis, and the oscillation axis selection unit 13 selects the Z-axis as the oscillation axis based on the predetermination result.

In the case of internal turning performed using a tool T being moved in the movement direction 3, the tool T can have one of the five cutting edge directions C, G, B, F, G, and A from among the cutting edge directions A to H. That is, in the case of the internal turning performed using the tool T being moved in the movement direction 3, it is impractical for the tool T to have any of the three cutting edge directions D, E, and H from the viewpoint of interference between the workpiece W and the tool T.

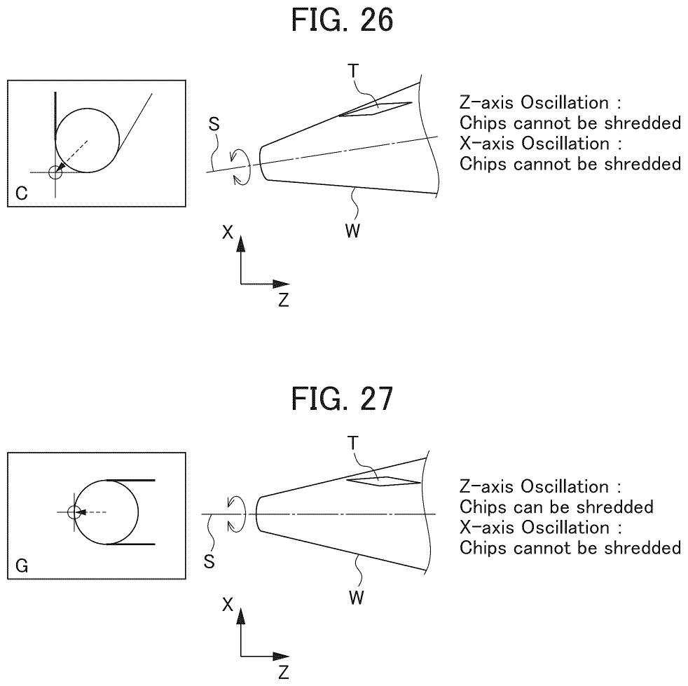

FIG. 26 is a diagram illustrating a Z-axis oscillation and an X-axis oscillation in a case of internal turning performed using a tool T which is moved in the movement direction 3, the tool shape (cutting edge direction) of which is unknown, and which has the cutting edge direction C. In this case, as illustrated in FIG. 26, chips cannot be shredded by the Z-axis oscillation or the X-axis oscillation.

FIG. 27 is a diagram illustrating a Z-axis oscillation and an X-axis oscillation in a case of internal turning performed using a tool T which is moved in the movement direction 3, the tool shape (cutting edge direction) of which is unknown, and which has the cutting edge direction G. In this case, as illustrated in FIG. 27, chips can be shredded by the Z-axis oscillation, but cannot be shredded by the X-axis oscillation.

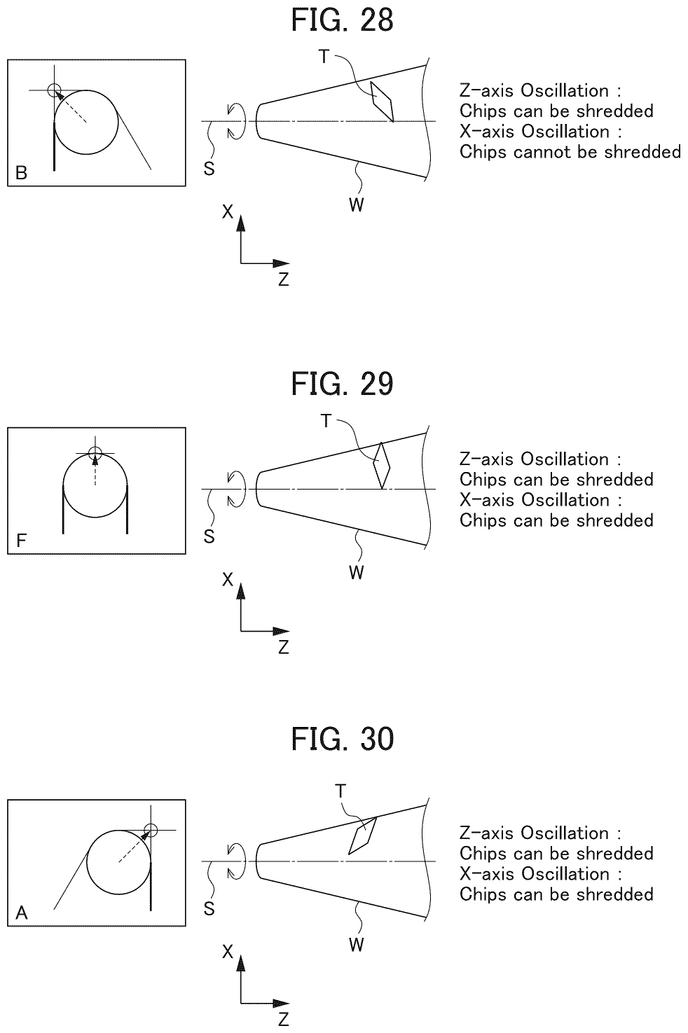

FIG. 28 is a diagram illustrating a Z-axis oscillation and an X-axis oscillation in a case of internal turning performed using a tool T which is moved in the movement direction 3, the tool shape (cutting edge direction) of which is unknown, and which has the cutting edge direction B. In this case, as illustrated in FIG. 28, chips can be shredded by the Z-axis oscillation, but cannot be shredded by the X-axis oscillation.

FIG. 29 is a diagram illustrating a Z-axis oscillation and an X-axis oscillation in a case of internal turning performed using a tool T which is moved in the movement direction 3, the tool shape (cutting edge direction) of which is unknown, and which has the cutting edge direction F. In this case, as illustrated in FIG. 29, chips can be shredded by either of the Z-axis oscillation and the X-axis oscillation.

FIG. 30 is a diagram illustrating a Z-axis oscillation and an X-axis oscillation in a case of internal turning performed using a tool T which is moved in the movement direction 3, the tool shape (cutting edge direction) of which is unknown, and which has the cutting edge direction A. In this case, as illustrated in FIG. 30, chips can be shredded by either of the Z-axis oscillation and the X-axis oscillation.

The above-described results of predetermination on shredding of chips illustrated in FIGS. 26 to 30 show that in the case of internal turning performed using a tool T which is moved in the movement direction 3 and the cutting edge direction of which is unknown, when chips can be shredded by the X-axis oscillation, they can be shredded by the Z-axis oscillation as well. That is, it is appreciated that in this case, the probability (percentage) of shredding chips is higher when the Z-axis oscillation is generated than when the X-axis oscillation is generated. Therefore, in the case of internal turning performed using a tool T which is moved in the movement direction 3 and of which the tool shape is unknown, a predetermination is made that the Z-axis having a higher probability of shredding chips should be selected as the oscillation axis, and the oscillation axis selection unit 13 selects the Z-axis as the oscillation axis based on the predetermination result.

As described above, according to the oscillating cutting of the present embodiment, if the positional relationship between the tool T and the workpiece W and the movement direction of the tool T are known, it is possible to select one axis to be oscillated in any of the cases described above.

However, as is apparent from the results of predetermination on shredding of chips illustrated in FIGS. 21 to 30, in a case where the workpiece W has a tapered shape, an arc shape, or a similar shape, and the tool T is moved in a plurality of movement directions, i.e., a plurality of axial directions (the Z-axis direction and the X-axis direction), the probability of shredding chips by the oscillation in one of the Z-axis direction and the X-axis direction is high but less than 100%, but the probability of shredding chips by the oscillation in the other is low and less than 100%. That is, it is not necessarily possible to shred 100% of chips even by the oscillation in the Z-axis direction or the X-axis direction. Therefore, a configuration may be adopted in which a predetermination is made that neither of the oscillation axes should be selected, and the oscillation axis selection unit 13 includes a selection stop unit that stops the oscillation without selecting any of the oscillation axes, based on the predetermination result. Accordingly, in the case where this configuration is adopted, even though there is no guarantee that chips are shredded, a user who positively tries to shred chips can adjust the settings by means of a prescribed operation means such that the oscillation axis selection unit 13 selects, from the Z-axis and the X-axis, one axis having a higher probability of shredding chips. On the other hand, a user who prefers to abstain from generating oscillation unless 100% of chips are able to be shredded can adjust the settings by a prescribed operation means such that the oscillation axis selection unit 13 does not select any oscillation axis.

In a case where the workpiece W has a cylindrical shape, a circular columnar shape, or a similar shape, and the tool T is moved in one movement direction, i.e., one axial direction (the Z-axis direction or the X-axis direction), the probability of shredding chips by oscillation in one of the Z-axis direction and the X-axis direction is 100%, and the probability of shredding chips by oscillation in the other direction is less than 100%. Accordingly, in this case, the oscillation axis selection unit 13 selects one axis in the same direction as the movement direction of the tool T as the oscillation axis. Specifically, by selecting, as the oscillation axis, one axis in the same direction as the movement direction, a 100% probability of shredding chips is achieved.

The predetermination results obtained in the above-described manner are set and inputted by the setting input unit 11 and retained by the retainer unit 12, in the form of table data of the predetermination results obtained for the combinations of the positional relationship data and the movement data, as shown in Table 2. Thus, based on the table data of the predetermination results shown in Table 2, the oscillation axis selection unit 13 executes processing of selecting, from among the plurality of feed axes, one specific axis as the oscillation axis for oscillating cutting that is performed by oscillating only one specific axis, or processing of abstaining from selecting any axis as the axis to be oscillated.

TABLE 2

| | G40 | G42 | G41 |
|---|---|---|---|
| 1 | ~ | ~ | ~ |
| 2 | ~ | Z-axis | ~ |
| 3 | ~ | Oscillation | Z-axis |
| 4 | ~ | ~ | Oscillation |
| 5 | ~ | ~ | ~ |
| 6 | ~ | ~ | ~ |
| 7 | ~ | ~ | ~ |
| 8 | ~ | ~ | ~ |

In Table 2, 1 to 8 represent the movement directions 1 to 8 of the tool T illustrated in FIGS. 2, and G40 to G42 represent the G codes illustrated in FIG. 6, which relate to tool diameter compensation and from which a positional relationship between the workpiece W and the tool T can be obtained.

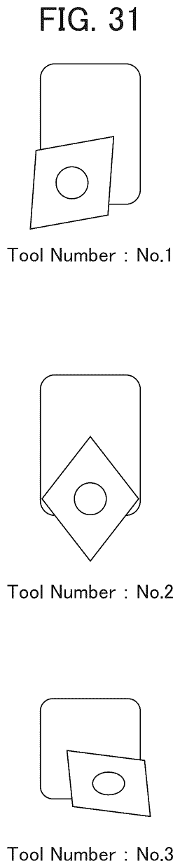

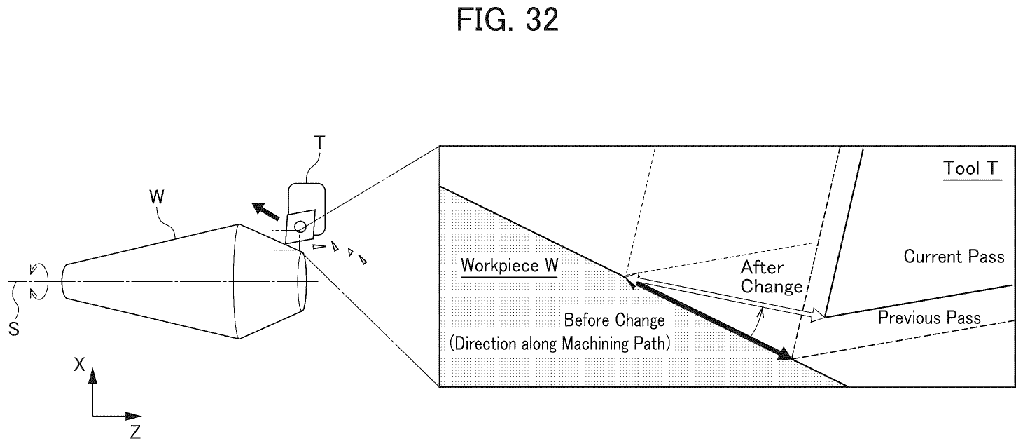

Next, a case where the oscillation axis is selected with reference to results of a predetermination made based on the tool-for-use data and the movement data will be described in detail with reference to FIG. 31. FIG. 31 is a diagram illustrating tools of tool numbers Nos. 1 to 3. The example illustrated in FIG. 31 illustrates the tool numbers Nos. 1 to 3 having different cutting edge directions.

The method of determining whether or not chips can be shredded based on the tool-for-use data and the movement data, and the method of determining, based on the determination result, whether one specific axis should be selected, from among a plurality of feed axes, as the oscillation axis for oscillating cutting that is performed by oscillating only one specific axis, or none of the plurality of feed axes should be selected as the axis to be oscillated, are the same as those based on the tool shape data and the movement data described above.

Therefore, the predetermination results based on the too-for-use data and the movement data are set and inputted by the setting input unit 11 and retained by the retainer unit 12, in the form of table data of the predetermination results obtained for the combinations of the tool-for-use data and the movement data, as shown in Table 3. Thus, based on the table data of the predetermination results shown in Table 3, the oscillation axis selection unit 13 executes processing of selecting, from among a plurality of feed axes, one specific axis as the oscillation axis for oscillating cutting that is performed by oscillating only one specific axis, or processing of abstaining from selecting any axis as the axis to be oscillated.

TABLE 3

| | No. 1 | No. 2 | No. 3 |
|---|---|---|---|
| 1 | ~ | ~ | ~ |
| 2 | Z-axis | ~ | ~ |
| 3 | Oscillation | Z-axis | ~ |
| 4 | ~ | Oscillation | ~ |
| 5 | ~ | ~ | ~ |
| 6 | ~ | ~ | ~ |
| 7 | ~ | ~ | ~ |
| 8 | ~ | ~ | ~ |

In Table 3, 1 to 8 represent the movement directions 1 to 8 of the tool T illustrated in FIG. 2, and Nos. 1 to 3 each represent the tool number of a tool to be used.

The above-described predetermination based on the tool shape data and the movement data is made for each of cutting edge directions of the tools, whereas the predetermination based on the tool-for-use data and the movement data is made for each tool to be used. Therefore, for example, when there are 100 tools, the former predetermination requires eight types of settings, whereas the latter predetermination requires 100 types of settings. This constitutes a difference between the former and the latter.

The present embodiment exerts the following effects.

According to the present embodiment, the machine tool control device 1 for a machine tool that performs oscillating cutting by oscillating only one specific axis includes the oscillation axis selection unit 13, which selects, from among a plurality of feed axes, one specific axis as the oscillation axis for oscillating cutting that is performed by oscillating only one specific axis, or abstains from selecting any of the plurality of feed axes as the axis to be oscillated, based on the tool shape data (cutting edge direction of the tool T) allowing for recognizing the tool shape, the positional relationship data indicating a positional relationship between the workpiece W and the tool T, the tool-for-use data allowing for identifying a tool to be used, and the movement data allowing for relatively moving the workpiece W and the tool T.

Due to this feature, the oscillation axis selection unit 13 of the present embodiment can automatically select one specific axis as the oscillation axis, or automatically abstains from selecting any axis as the axis to be oscillated, based on a combination of the tool shape data (cutting edge direction of the tool T) and the movement data, a combination of the positional relationship data indicating a positional relationship between the workpiece W and the tool T and the movement data, or a combination of the tool-for-use data and the movement data. Therefore, the present embodiment makes it possible to reduce the workload on a user who selects one specific axis to be oscillated during machining.

It should be noted that the present disclosure is not limited to the above-described embodiments, and modifications and improvements to the extent that the object of the present disclosure can be achieved are encompassed in the scope of the present disclosure.

In the above embodiments, the present invention is applied to the machine tool control device 1. However, this is a non-limiting example. For example, the present invention can be applied to the above-described host computer or the like. That is, the present invention can provide an information processing device including the setting input unit 11, the retainer unit 12, the oscillation axis selection unit 13, and an output unit that outputs a result of selection by the oscillation axis selection unit 13. In this case, the same effect as in the above embodiment can be exerted, and the result of selection of the oscillation axis can be outputted and notified to the user. Furthermore, the present invention can be applied to a computer program for causing a computer to execute the oscillation axis selection step by the oscillation axis selection unit 13 and the output step by the output unit.

### EXPLANATION OF REFERENCE NUMERALS

1: Machine tool control device
11: Setting input unit
12: Retainer unit
13: Oscillation axis selection unit
14: Oscillation control unit
15: Storage Unit
3: Motor
S: Spindle
T: tool
W: Workpiece

1. An information processing device comprising:
an oscillation axis selection unit that selects, from among a plurality of feed axes, one specific axis as an oscillation axis for oscillating cutting that is performed by oscillating only one specific axis, or abstains from selecting any of the plurality of feed axes as an axis to be oscillated, based on tool shape data allowing for recognizing a tool shape, positional relationship data indicating a positional relationship between a workpiece and a tool, or tool-for-use data allowing for identifying a tool to be used, and movement data allowing for relatively moving the workpiece and the tool; and
an output unit that outputs a result of selection by the oscillation axis selection unit.

2. The information processing device according to claim 1, further comprising:
a retainer unit that retains predetermination results indicating that one specific axis should be selected, from among the plurality of feed axes, as the oscillation axis for oscillating cutting that is performed by oscillating only one specific axis, or indicating that none of the plurality of feed axes should be selected as the axis to be oscillated, for each of a combination of the tool shape data and the movement data, a combination of the positional relationship data and the movement data, and a combination of the tool-for-use data and the movement data, wherein
the oscillation axis selection unit selects, from among the plurality of feed axes, one specific axis as the oscillation axis for oscillating cutting that is performed by oscillating only one specific axis, or abstains from selecting any of the plurality of feed axes as the axis to be oscillated, based on the predetermination results retained by the retainer unit.

3. The information processing device according to claim 2, further comprising:
a setting input unit that sets and inputs the predetermination results.

4. A machine tool control device for a machine tool that performs oscillating cutting by oscillating only one specific axis, the machine tool control device comprising:
an oscillation axis selection unit that selects, from among a plurality of feed axes, one specific axis as an oscillation axis for oscillating cutting that is performed by oscillating only one specific axis, or abstains from selecting any of the plurality of feed axes as an axis to be oscillated, based on tool shape data allowing for recognizing a tool shape, positional relationship data indicating a positional relationship between a workpiece and a tool, or tool-for-use data allowing for identifying a tool to be used, and movement data allowing for relatively moving the workpiece and the tool; and
an oscillation control unit that performs control to oscillate the one specific axis selected by the oscillation axis selection unit or control not to oscillate any of the feed axes, based on a machining condition and a result of selection by the oscillation axis selection unit.

5. The machine tool control device according to claim 4, further comprising:
a retainer unit that retains predetermination results indicating that one specific axis should be selected, from among the plurality of feed axes, as the oscillation axis for oscillating cutting that is performed by oscillating only one specific axis, or indicating that none of the plurality of feed axes should be selected as the axis to be oscillated, for each of a combination of the tool shape data and the movement data, a combination of the positional relationship data and the movement data, and a combination of the tool-for-use data and the movement data, wherein
the oscillation axis selection unit selects, from among the plurality of feed axes, one specific axis as the oscillation axis for oscillating cutting that is performed by oscillating only one specific axis, or abstains from selecting any of the plurality of feed axes as the axis to be oscillated, based on the predetermination results retained by the retainer unit.

6. The machine tool control device according to claim 5, further comprising:
a setting input unit that sets and inputs the predetermination results.

7. A computer program for causing a computer to execute steps that comprise:
an oscillation axis selection step of selecting, from among a plurality of feed axes, one specific axis as an oscillation axis for oscillating cutting that is performed by oscillating only one specific axis, or abstaining from selecting any of the plurality of feed axes as an axis to be oscillated, based on tool shape data allowing for recognizing a tool shape, positional relationship data indicating a positional relationship between a workpiece and a tool, or tool-for-use data allowing for identifying a tool to be used, and movement data allowing for relatively moving the workpiece and the tool; and
an output step of outputting a result of selection made in the oscillation axis selection step.
